(19) United States
(12) Patent Application Publication
(10) Pub. No.: US 2008/0145037 A1
(43) Pub. Date: Jun. 19, 2008

(54) EXTERNAL VIDEO RECORDER

(75) Inventor: Isao Murase, Cupertino, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: SONY CORPORATION, Tokyo (JP); SONY ELECTRONICS INC., Park Ridge, NJ (US)

(21) Appl. No.: 11/610,413

(22) Filed: Dec. 13, 2006

(51) Int. Cl. H04N 5/00

(52) U.S. Cl. 386/126

(57) ABSTRACT

An external recording device that allows recording of content from a set top box or similar device. The external recording device works as a slave device to the target set top box via a communication interface such as IEEE1394, USB, Ethernet, SATA or other forms of digital output, allowing the set top box to take full control of the external device to record programming from the set top box to a portable media.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to video recorders and more particularly to external video recorders for recording video from a set top box (STB).

2. Description of Related Art

The majority of currently available STB's (e.g. digital video recording boxes (DVR), cable or satellite tuners, etc.), particularly leased boxes from multi-channel operators, do not include the ability to record programming on a moveable or portable media (e.g. an optical disc recorder such as DVD).

When a user desires to archive or transfer data from the STB, they have to connect a retail DVD recorder or like device using analog connections and manually control each device (e.g. playback and stop) separately. Recording can only be done in real time, and requires the user to coordinate operation of two separate devices.

Currently, there are third party retail set top boxes with built in did recorders. However, these do not help those consumers using leased set top boxes.

### BRIEF SUMMARY OF THE INVENTION

An aspect of the invention is an external recording device that allows recording of content from a STB. The external recording device works as a slave device to the target set top box via a communication interface such as IEEE1394, USB, Ethernet, SATA or other forms of digital output, allowing the set top box to take full control of the drive.

By providing a two-way digital interface between the set top box and the drive, the end user can transfer recorded contents on the set top box by using only the set top box interface. The set top box will therefore control the drive and eliminate the need for operating the drive separately (e.g. a second remote control and/or user interface.)

Another aspect of the invention is an apparatus for externally recording video data from a set top box. The apparatus has an optical recording means for recording the video data on a portable recording medium, and a digital interface coupled to the optical recording means. The digital interface is configured to support two-way transmission of data between the external recorder and the set top box, and the optical recording means is configured to receive commands from the set top box user interface to receive the video data for recording the video data on the portable recording medium.

In a preferred embodiment, the optical recording means is configured to operate as a slave device to the set top box. For example, recording means may be one or more of the following devices: a DVD recorder; Blue-ray, or HD DVD recorder. Accordingly, the digital interface may be one of the following: IEEE1394, Ethernet, USB, or SATA.

In one embodiment, the apparatus includes a processor coupled to the digital interface and the optical recording means, wherein the processor is configured to facilitate two-way communication between the optical recording means and the set top box.

In another embodiment, the apparatus also includes an external input for an auxiliary storage device, the auxiliary storage device also being configured to store video data from the set top box. In come cases, the processor is configured to recognize whether an optical disc or auxiliary storage device is installed, so that the processor automatically directs data transferred from the set top box to the installed device.

In yet another embodiment, the processor is configured to control transfer of video data based on preset parameters. The preset parameters may be a function of DRM associated with the video data.

In a further embodiment, the set top box user interface comprises a selection for recording one or more content items on the optical recording means. The user interface may also include a queue of content items for recording on the optical recording means.

Another aspect is a method for recording video from a set top box. The method includes the steps of coupling an external video recorder to the set top box via a digital interface, controlling operation of the optical recording device via a user interface of the set top box, transmitting video data from the set top box to the external video recorder, and recording the video data on a portable recording medium coupled to the external recorder.

The video data may be recorded on a portable recording medium by storing digital data on one or more of the following: a DVD; Blue-ray, or HD DVD.

In one embodiment, the method includes coupling an auxiliary storage device to the external recorder, wherein the auxiliary storage device is configured to store video data from the set top box.

In yet another embodiment, the method includes controlling transfer of video data based on preset parameters (e.g. DRM or other data associated with the video data).

A further aspect is a system for externally recording video data from a set top box. The system includes an external video recorder configured to record the video data on a portable recording medium, wherein the external video recorder is configured to be coupled to a set top box via a digital interface supporting two-way transmission of data between the external recorder and the set top box. The external video recorder is configured to receive commands from the set top box user interface to record the video data on the portable recording medium.

In one embodiment of the current aspect, the set top box user interface comprises a selection for recording one or more content items on the external recorder. The user interface may also include a queue of content items for recording on the external recorder.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram of a home video system incorporating an external video recorder in accordance with the present invention.

FIG. 2 illustrates the external video recorder of the present invention.

FIG. 3 is a diagram of the external video recorder shown in FIG. 3.

FIG. 4 is exemplary flow diagram for operating the recorder of the present invention under a typical set-top-box (STB) user interface.

FIG. 5 illustrates a user interface display screen in accordance with the present invention.

FIG. 6 is another user interface display for recording content to the recorder of the present invention.

### DETAILED DESCRIPTION OF THE INVENTION

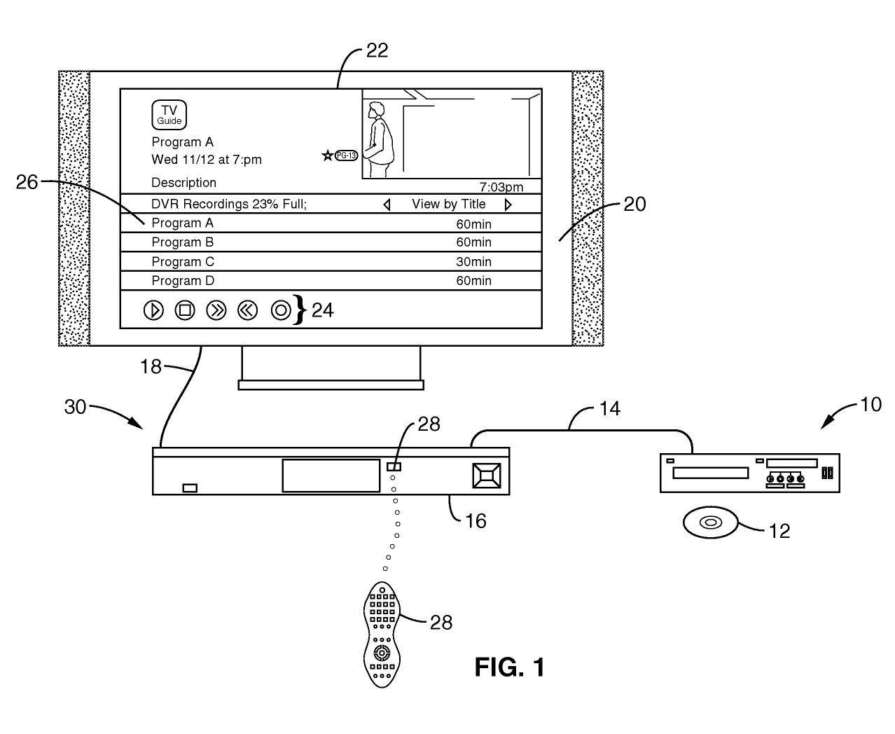

Referring more specifically to the drawings, for illustrative purposes the present invention is embodied in the apparatus generally shown in FIG. 1 through FIG. 6. It will be appreciated that the apparatus may vary as to configuration and as to details of the parts, and that the method may vary as to the specific steps and sequence, without departing from the basic concepts as disclosed herein.

FIG. 1 illustrates home video system 30 incorporating external video recorder 10 in accordance with the present invention. The recorder 10 is coupled to set top box (STB) 16 via cable 14 that connects the devices through communication port 28 (e.g. IEEE 1394, USB, Ethernet, SATA, or other forms of digital interface) in the STB. STB 16 may comprise a satellite cable, IPTV or like receiver that is generally configured to receive programming, and may or may not include recording capability such DVR, TIVO, etc.

Recorder 10 is configured to record data from the STB 16 onto portable media 12, which may comprise an optical dick such as DVD, Blu-ray, HD DVD, or the like. This allows the user to archive or transfer data that may be stored on a hard drive in the STB 16, or record live programming from DVR or conventional STB.

Recorder 10 is further configured to act as a slave device, through cable 14, to the STB 16, such that it can be controlled through the STB 16 controls or user interface. FIG. 1 illustrates a TV or monitor 20 that is coupled to the STB 16 via cable 18. STB 16 is generally configured to display programming from a multi-channel operator, e.g. Comcast, DISH, etc. via user interface 22. The user interface 22 typically allows selection of programs 26 through menu or on-screen commands 24 that are selected via a remote control 28.

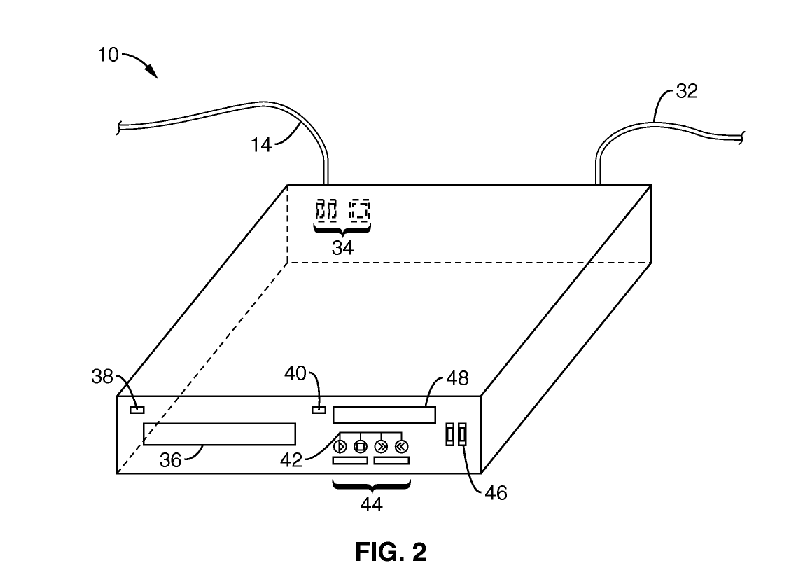

FIG. 2 illustrates an exemplary external video recorder 10 in accordance with the present invention. The recorder 10 generally comprises one or more communication ports 34 (e.g. IEEE 1394, USB, Ethernet, SATA, etc.) that allows two-way communication from the recorder 10 to the STB 16 via cable 14, and allows control commands from the STB to the video recorder. The recorder 10 has a power cord 32 coupled to a power supply (not shown) and power button 38 for manually turning the device on/off.

The recorder 10 preferably comprises an optical media read/write recording means 36, which is configured to record to a portable optical disk such as a CD, DVD, HD DVD or the like. The recordable media may be inserted or ejected via manually pressing open/close button 40 that is configured to extend/retract the bay of recording device 36. The optical recording means may also be high speed (i.e. fast than 1× recording).

The recorder 10 may also have a plurality of inputs 46 for attaching an additional drive, e.g. external hard drive, portable media player such as an MP3 player, USB flash memory or the like. Flash media bays 44 may also be provided for reading/writing flash memory that is capable of storing data from the STB 16. The recorder may also have controls 42 for controlling playback of the installed media, or for determining where data is stored (e.g. via optical disk drive 36, flash output 44, or external device output 46).

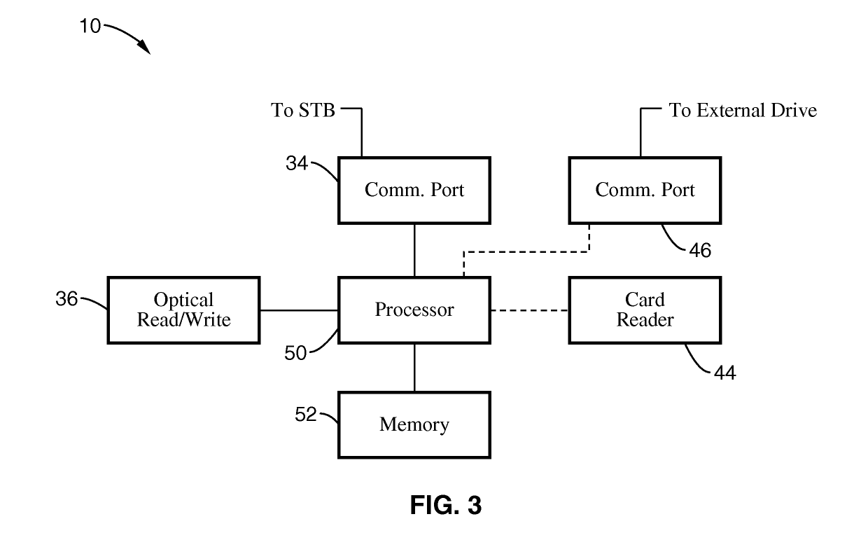

FIG. 3 illustrates a diagram of the digital video recorder 10 in accordance with the present invention. Recorder 10 comprises a processor 50 and memory 52 for storing commands/code/software for communication to and from the STB 16. In addition, the processor may be configured to sense when media is placed in or connected to the recorder 10, e.g. a flash card in reader 44, disk loaded media bay 36, or media player or external hard drive (not shown) coupled to communication port 46, such that a command from the STB 16 to record data to the recorder 10 is directed to automatically send the data to the device plugged in. For example, if a flash memory card is plugged in bay 44, data is automatically written to it when a record prompt is given. If more than one recording media is plugged in, recording may be done on one or more of the media by manual selection via controls 42, or the user interface 22 of the STB 16. In addition to portable media, recorder 10 may also comprise an internal hard drive (not shown) to provide additional back up storage for the STB.

Table 1 illustrates exemplary content type/data settings matrix that can be implemented for operation of the recorder 10. It is appreciated that the matrix may be varied as desired for flexibility in recording requirements. For example, recorded content on the DVR 16 (e.g. in MPEG2 TS format) can be transferred to a DVD 12 in recorder 10 such that SD video is copied freely as DVD video, and SD video having DRM/CPRM may be moved to the DVD as data under a copy once. Certain copyrighted material may also be specified to never be copied. In addition, HD content may be specified for data archiving only, and that content may be split into multiple discs.

The recorder 10 may also be configured for playback to the STB 16. In one embodiment, only discs recorded by the recorder 10 are supported for playback, with no support for commercial DVD's or other discs created by other devices.

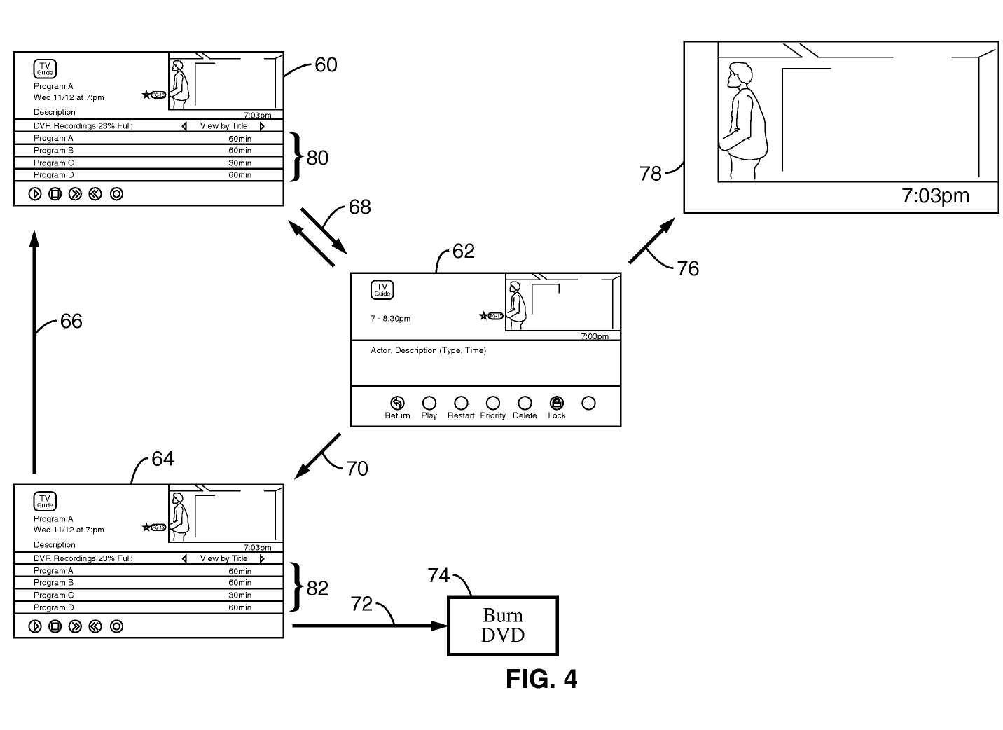

FIG. 4 illustrates an exemplary flow diagram for operating the recorder 10 under the STB 16 user interface 22. The user interface will generally comprise a main screen 60 having a content list of recorded items (HDD &DVD). Individual content items (broadcast programs, etc.), may be individually selected at step 68 (e.g. by scrolling and selecting with remote control 28) so that content screen 62 is pulled up showing the details of that content item. The content screen 62 includes options such delete, priority, and playback selection 76 to generate playback screen 78. In addition, the individual content items may be selected at step 70 for recording into a recording queue 64 having a list of content items to be recorded 82. With the desired list of content items generated in the queue 64, the content data is selected for recording 72 to burn onto a DVD or like media 74.

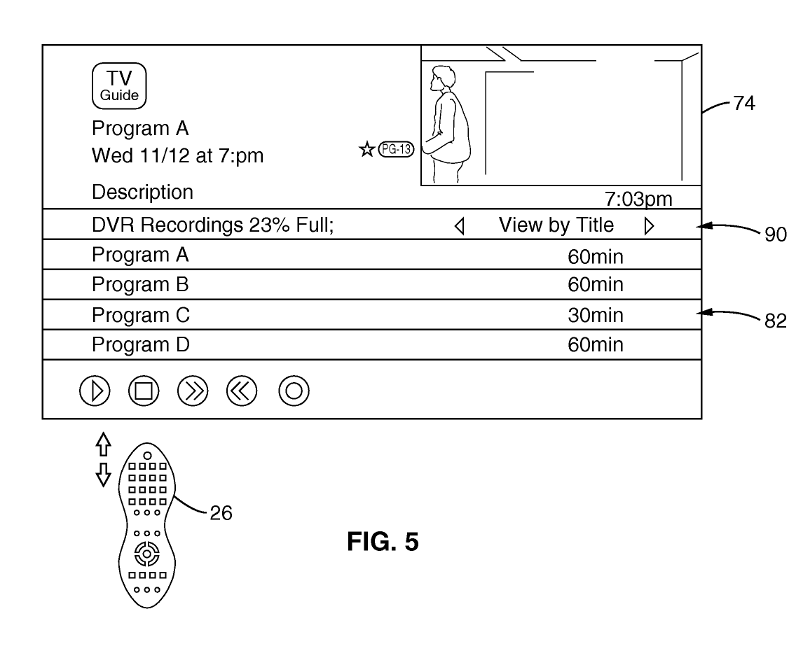

FIG. 5 illustrates a detailed view of recording queue screen 74, configured for operation with external recorder 10 in accordance with the present invention. The user interface may have a “record to media” button 90, or pull-down menu, for recording the queue content items on the external recorder 10. In some embodiments, several external recording options may be available for recording to different recording media coupled to the recorder 10, e.g. flash memory card 44 or disc 12.

The recording queue list 82 may be further manipulated, e.g. order and/or composition of content items, etc., with use of the STB remote 26, (e.g. up and down arrow keys and select button). Individual content items may be selected to view the full metadata associated with the program (e.g. screen 62 in FIG. 4), and selected or added to queue 82 as desired.

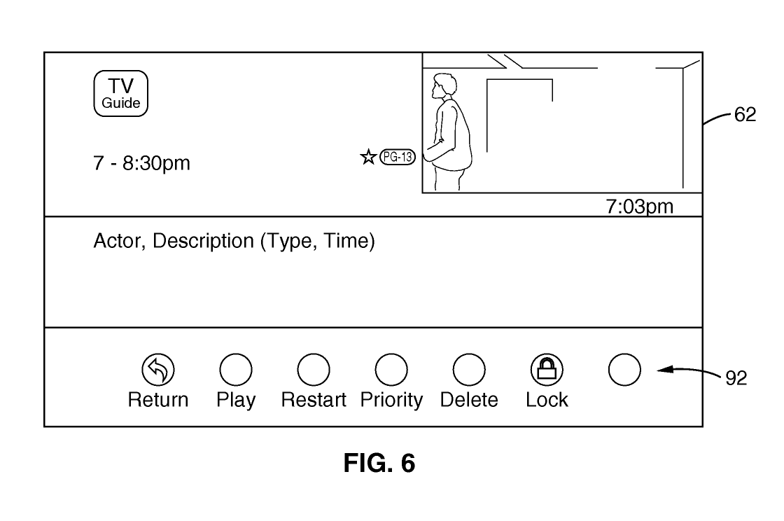

Referring to FIG. 6, the content item screen 62 may also be configured to control current or future operation of the external recorder 10. For example, record button 92 may be selected to pull up a drop-down list or screen of menu options for recording the particular program. For example, the recording menu may include typical DVR menu options such as record single occurrence or record series. In addition, options may be available to record an already stored program (e.g. in the STB 16 memory). In some embodiments, the user may have the option to record a live program on the STB 16 hard drive, or directly to the external recorder (e.g. burn DVD or to the recorder hard drive, if available). A recording priority may also be set between the STB 16 memory and other external recording options. For example, STB 16 memory may be ranked first, and the recorder 10 second, such that in the situation where STB 16 has exceeded available memory, a scheduled program will be automatically recorded on external recorder to act as an overflow.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1

| | MPG2 SD | | | MPG2 SD | | |
|---|---|---|---|---|---|---|
| | | Copy | Never | Copy | Copy | Never |
| | Copy freely | once | copy | freely | once | copy |
| Record | Copy | Move | | Copy | No | |
| | DVD Video | DVD | | MPEG2-T | X | |
| | | video with | | Data | | |
| | | CPRM | | | | |
| Play- | MPEG2-TS | MPEG2- | | MPEG2- | | |
| back | back to | TS back | | TS back | | |
| | STB | to STB | | to STB | | |

What is claimed is:

1. An apparatus for externally recording video data from a set top box, comprising:
an optical recording means for recording the video data on a portable recording medium; and
a digital interface coupled to the optical recording means;
the digital interface configured to support two-way transmission of data between the external recorder and the set top box;
wherein the optical recording means is configured to receive commands from the set top box user interface to receive the video data for recording the video data on said portable recording medium.

2. An apparatus as recited in claim 1, wherein the optical recording means is configured to operate as a slave device to the set top box.

3. An apparatus as recited in claim 1, wherein the recording means comprises one or more of the following: a DVD recorder; Blue-ray, or HD DVD recorder.

4. An apparatus as recited in claim 1, wherein the digital interface comprises one of the following: IEEE1394, Ethernet, USB, or SATA.

5. An apparatus as recited in claim 1, further comprising:
a processor coupled to the digital interface and the optical recording means;
wherein the processor is configured to facilitate two way communication between the optical recording means and the set top box.

6. An apparatus as recited in claim 5, further comprising:
an external input for an auxiliary storage device;
wherein the auxiliary storage device is configured to store video data from the set top box.

7. An apparatus as recited in claim 6, wherein the processor is configured to recognize whether an optical disc or auxiliary storage device is installed; and
wherein the processor automatically directs data transferred from the set top box to the installed device.

8. An apparatus as recited in claim 5;
wherein the processor is configured to control transfer of video data based on preset parameters.

9. An apparatus as recited in claim 8;
wherein the preset parameters are a function of DRM associated with the video data.

10. An apparatus as recited in claim 1;
wherein set top box user interface comprises a selection for recording one or more content items on the optical recording means.

11. An apparatus as recited in claim 11;
wherein the user interface comprises a queue of content items for recording on the optical recording means.

12. A method for recording video from a set top box, comprising:
coupling an external video recorder to the set top box via a digital interface;
controlling operation of the optical recording device via a user interface of the set top box;
transmitting video data from the set top box to the external video recorder; and
recording the video data on a portable recording medium coupled to the external recorder.

13. A method as recited in claim 12, wherein the external video recorder is configured to operate as a slave device to the set top box.

14. A method as recited in claim 1, wherein recording the video data on a portable recording medium comprises storing digital data on one or more of the following: a DVD; Blue-ray, or HD DVD.

15. A method as recited in claim 1, wherein the external video recorder is coupled to the set top box via IEEE1394, Ethernet, USB, or SATA connection.

16. A method as recited in claim 5, further comprising:
coupling an auxiliary storage device to the external recorder;
wherein the auxiliary storage device is configured to store video data from the set top box.

17. A method as recited in claim 1, further comprising:
controlling transfer of video data based on preset parameters.

18. A method as recited in claim 17;
wherein the preset parameters are a function of DRM associated with the video data.

19. A system for externally recording video data from a set top box, comprising:
an external video recorder configured to record the video data on a portable recording medium;
wherein the external video recorder is configured to be coupled to a set top box via a digital interface supporting two-way transmission of data between the external recorder and the set top box; and
wherein the external video recorder is configured to receive commands from the set top box user interface to record said video data on said portable recording medium.

20. A system as recited in claim 19;
wherein the external recorder is configured to control transfer of video data based on preset parameters.

21. A system as recited in claim 20;
wherein the preset parameters are a function of DRM associated with the video data.

22. A system as recited in claim 19;
wherein set top box user interface comprises a selection for recording one or more content items on the external recorder.

23. A system as recited in claim 22;
wherein the user interface comprises a queue of content items for recording on the external recorder.
